(19) United States
(12) Patent Application Publication
(10) Pub. No.: US 2024/0416723 A1
(43) Pub. Date: Dec. 19, 2024

(54) VEHICULAR REFRIGERATION CYCLE UNIT

(71) Applicant: MITSUBISHI HEAVY INDUSTRIES THERMAL SYSTEMS, LTD., Tokyo (JP)

(72) Inventors: Hideto NOYAMA, Tokyo (JP); Takayuki KOBAYASHI, Tokyo (JP); Nobuya NAKAGAWA, Tokyo (JP); Katsuhiro SAITO, Tokyo (JP); Masatoshi MORISHITA, Tokyo (JP); Hirotaka TANABE, Tokyo (JP); Hirofumi HIRATA, Tokyo (JP); Shinya HAMAMOTO, Tokyo (JP)

(73) Assignee: MITSUBISHI HEAVY INDUSTRIES THERMAL SYSTEMS, LTD., Tokyo (JP)

(21) Appl. No.: 18/704,340

(22) PCT Filed: Nov. 4, 2021
(86) PCT No.: PCT/JP2021/040632

§ 371 Date: Apr. 24, 2024

(51) Int. Cl. B60H 1/00

(52) U.S. Cl. CPC B60H 1/00978

(57) ABSTRACT

Provided is a vehicular refrigeration cycle unit that is interposed between a vehicle-outside heat exchanger and a vehicle-inside heat exchanger and that exchanges heat between secondary refrigerants respectively flowing through the vehicle-outside heat exchanger and the vehicle-inside heat exchanger. The vehicular refrigeration cycle unit includes a refrigeration cycle provided in a device accommodation space inside a vehicle, the refrigeration cycle including a compressor, a condenser, an expansion valve, and an evaporator through which a primary refrigerant having flammability and having a higher specific gravity than atmosphere flows sequentially, and a leakage sensor located below the compressor, the condenser, and the evaporator and is configured to detect the concentration of the primary refrigerant contained in air in the device accommodation space.

### TECHNICAL FIELD

The present disclosure relates to a vehicular refrigeration cycle unit.

### BACKGROUND ART

Patent Document 1 discloses a refrigeration cycle constituting a vehicular heat management system and including devices such as a compressor, a thermal fluid cooler (evaporator), and a thermal fluid heater (condenser) accommodated in a case having thermal insulating properties.

### CITATION LIST

### Patent Literature

Patent Document 1: JP 2014-201224 A

### SUMMARY OF INVENTION

### Technical Problem

In a refrigeration cycle in which a primary refrigerant is compressed and condensed, the primary refrigerant may leak from the device after long-term use. The compressor, the evaporator, and the condenser of the refrigeration cycle described in Patent Document 1 above are accommodated in the case in individual spaces defined by partition walls of the case. Thus, if the primary refrigerant leaks from any of these devices, for example, it is difficult to determine the presence or absence of the leakage, which is a problem.

The present disclosure has been made to solve the above problem, and an object of the present disclosure is to provide a vehicular refrigeration cycle unit that can determine the presence or absence of a leakage of a primary refrigerant.

### Solution to Problem

To solve the problem described above, a vehicular refrigeration cycle unit according to the present disclosure is a vehicular refrigeration cycle unit interposed between a vehicle-outside heat exchanger and a vehicle-inside heat exchanger and being configured to exchange heat between respective secondary refrigerants flowing through the vehicle-outside heat exchanger and the vehicle-inside heat exchanger, the refrigeration cycle unit including: a refrigeration cycle provided in a device accommodation space inside a vehicle, the refrigeration cycle including a compressor, a condenser, an expansion valve, and an evaporator through which a primary refrigerant having flammability and having a higher specific gravity than atmosphere flows sequentially; and a leakage sensor located below the compressor, the condenser, and the evaporator and being configured to detect a concentration of the primary refrigerant contained in air in the device accommodation space.

### Advantageous Effects of Invention

According to the present disclosure, a vehicular refrigeration cycle unit that can determine the presence or absence of a leakage of a primary refrigerant can be provided.

### BRIEF DESCRIPTION OF DRAWINGS

FIG. 1 is a system diagram illustrating a configuration of a vehicular air conditioning system (during a heating operation) according to an embodiment.

FIG. 2 is a diagram illustrating a configuration of a vehicular refrigeration cycle unit according to an embodiment.

FIG. 3 is a functional block diagram illustrating a configuration of a refrigeration-cycle-side control device according to an embodiment.

FIG. 4 is a flowchart illustrating an operation of the refrigeration-cycle-side control device according to an embodiment.

FIG. 5 is a hardware configuration diagram illustrating a configuration of a computer according to an embodiment.

FIG. 6 is a system diagram illustrating a configuration of the vehicular air conditioning system (during a cooling operation) according to an embodiment.

### DESCRIPTION OF EMBODIMENTS

Hereinafter, a vehicular air conditioning system according to an embodiment of the present disclosure will be described with reference to the drawings.

### Vehicular Air Conditioning System

A vehicular air conditioning system is a device that is installed in an electric vehicle or the like and that conditions air in a vehicle cabin. A difference in temperature between the inside and the outside of the vehicle cabin is regulated by the vehicular air conditioning system. In the present embodiment, a configuration in which the vehicular air conditioning system performs a heating operation will be described as an example.

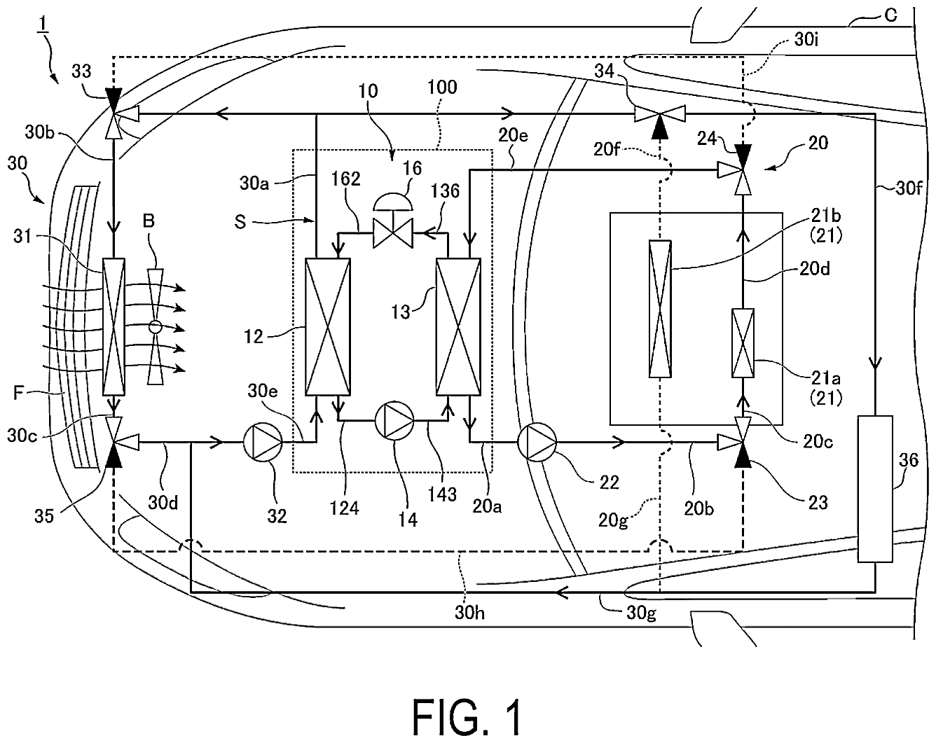

As illustrated in FIG. 1, a vehicular air conditioning system 1 includes a vehicular refrigeration cycle unit 100, a vehicle-inside thermal fluid circuit 20, and a vehicle-outside thermal fluid circuit 30.

In the drawings, among various lines (pipes) included in the vehicular refrigeration cycle unit 100, the vehicle-inside thermal fluid circuit 20, and the vehicle-outside thermal fluid circuit 30, lines in an open state through which a refrigerant can flow are indicated by solid lines, and lines in a closed state through which a refrigerant cannot flow are indicated by broken lines. In addition, among the various valves, valves in black indicate a closed state, and valves in white indicate an open state.

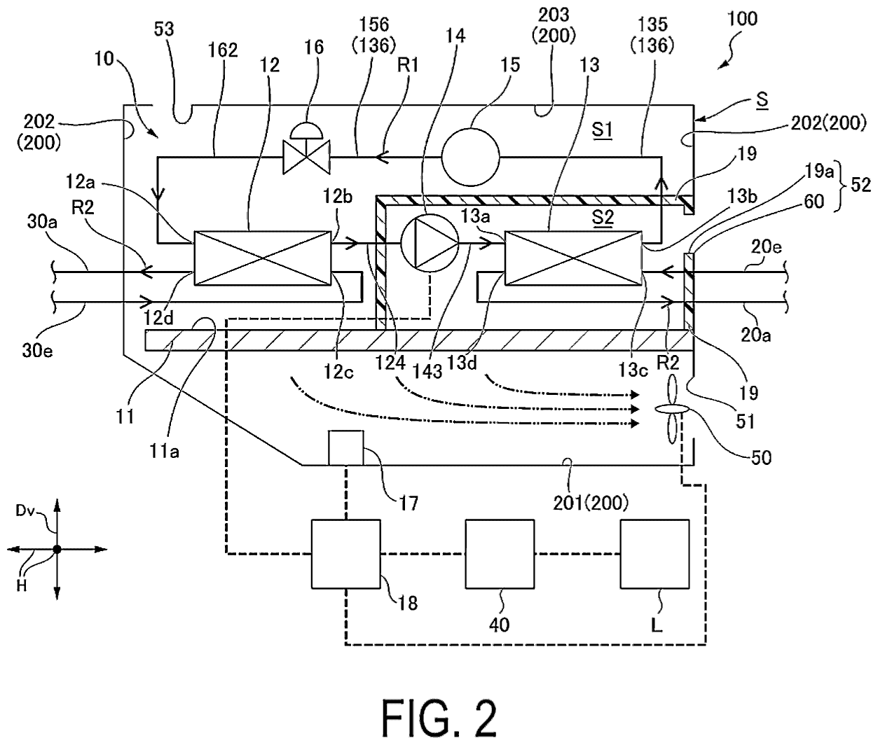

As illustrated in FIGS. 1 and 2, the vehicular refrigeration cycle unit 100 is provided in a device accommodation space S inside a vehicle C. The device accommodation space S in the present embodiment is, for example, a front compartment located on a front side of the vehicle C. When the device accommodation space S is the front compartment, a bottom wall portion 201 including a bottom surface and a side wall portion 202 including a side surface are formed of metal or the like. The bottom wall portion 201 and the side wall portion 202 are vehicle body inner walls 200 constituting the device accommodation space S.

A metal hood 203 that can close the device accommodation space S from above is provided above the device accommodation space S defined by the bottom wall portion 201 and the side wall portion 202. That is, the hood 203 corresponds to a ceiling of the vehicle body inner wall 200 that makes the device accommodation space S a closed space. The side wall portion 202 of the vehicle body inner wall 200 is formed with a hole portion 60 that communicates the device accommodation space S with the atmosphere outside the vehicle C.

### Vehicular Refrigeration Cycle Unit

The vehicular refrigeration cycle unit 100 is a device that circulates a primary refrigerant R1 that exchanges heat with a secondary refrigerant R2 used for in-vehicle air conditioning. As the primary refrigerant R1 in the present embodiment, for example, an R290 refrigerant (propane), which is a highly flammable hydrocarbon having a specific weight greater than the specific weight of air, is employed.

The vehicular refrigeration cycle unit 100 includes a base plate 11, a refrigeration cycle 10, various lines (a suction line 124, a discharge line 143, a pre-expansion line 136, and a post-expansion line 162), a casing 19, a leakage sensor 17, a first ventilating port 51, a ventilating fan 50, an air intake 53, a second ventilating port 52, and a refrigeration-cycle-side control device 18 (control device).

### Base Plate

The base plate 11 is a member having a flat plate shape and is provided in the device accommodation space S. The base plate 11 includes a main surface 11a facing an upper side in a vertical direction Dv, which is a direction coinciding with the direction of gravity. In other words, the base plate 11 extends in a horizontal direction H perpendicular to the vertical direction Dv such that the main surface 11a faces upward. As a material constituting the base plate 11 a metal or a synthetic resin, for example, is used.

### Refrigeration Cycle

The refrigeration cycle 10 includes multiple devices that configure a thermodynamic cycle. The refrigeration cycle 10 is a refrigerant circuit in which, in order to cause the primary refrigerant R1 serving as a thermal fluid to exchange heat with the secondary refrigerant R2, the primary refrigerant R1 sequentially flows and circulates through the multiple devices while being repeatedly compressed and condensed and expanded and evaporated.

The refrigeration cycle 10 is provided in the device accommodation space S. The refrigeration cycle 10 includes an evaporator 12, a compressor 14, a condenser 13, a receiver 15, and an expansion valve 16. These components are sequentially connected by pipes through which the primary refrigerant R1 flows.

### Evaporator

The evaporator 12 is a plate-type heat exchanger that evaporates (vaporizes) the primary refrigerant R1 by heat exchange between the primary refrigerant R1 sequentially flowing through the refrigeration cycle 10 and the secondary refrigerant R2 introduced from the outside of the vehicular refrigeration cycle unit 100. The primary refrigerant R1 in the evaporator 12 is heated by the secondary refrigerant R2 while simultaneously cooling the secondary refrigerant R2. Although not illustrated in FIG. 2 for convenience, the evaporator 12 is fixed to the main surface 11a of the base plate 11.

### Compressor

The compressor 14 is a device that compresses the primary refrigerant R1 having been vaporized by passing through the evaporator 12. The pressure of the primary refrigerant R1 introduced into the compressor 14 is increased through compression by the compressor 14 to a predetermined pressure higher than the pressure before the compression. As a result, the temperature of the primary refrigerant R1 becomes higher than before the compression. Although not illustrated in FIG. 2 for convenience, the compressor 14 is fixed to the main surface 11a of the base plate 11.

The compressor 14 and the evaporator 12 are connected to each other by the suction line 124. That is, one end of the suction line 124 is connected to a primary refrigerant outlet section 12b of the evaporator 12, and the other end of the suction line 124 is connected to a suction port of the compressor 14.

### Condenser

The condenser 13 is a plate-type heat exchanger that condenses (liquefies) the primary refrigerant R1 by heat exchange between the primary refrigerant R1, which has a higher temperature and a higher pressure than before being compressed by passing through the compressor 14, and the secondary refrigerant R2 introduced from the outside of the vehicular refrigeration cycle unit 100. The primary refrigerant R1 in the condenser 13 is cooled by the secondary refrigerant R2 while simultaneously heating the secondary refrigerant R2. Although not illustrated in FIG. 2 for convenience, the condenser 13 is fixed to the main surface 11a of the base plate 11.

The condenser 13 and the compressor 14 are connected to each other by the discharge line 143. That is, one end of the discharge line 143 is connected to a discharge port of the compressor 14, and the other end of the discharge line 143 is connected to a primary refrigerant inlet section 13a of the condenser 13.

### Receiver

The receiver 15 is a gas-liquid separator that receives the primary refrigerant R1 which has become a fluid in a gas-liquid mixed state by passing through the condenser 13, separates the primary refrigerant R1 into a gas phase and a liquid phase, and temporarily retains the gas phase and the liquid phase.

The receiver 15 and the condenser 13 are connected to each other by a first line 135 of the pre-expansion line 136. That is, one end of the first line 135 is connected to a primary refrigerant outlet section 13b of the condenser 13, and the other end of the first line 135 is connected to a refrigerant inlet section located at a lower end of the receiver 15. Note that, the receiver 15 is supported by the first line 135 connected to the condenser 13, and is held at a position separated from the main surface 11a of the base plate 11, for example.

The primary refrigerant R1 in the gas-liquid mixed state and introduced into the receiver 15 flows into the liquid phase portion retained in the receiver 15. The liquid portion of the primary refrigerant R1 thus introduced is added to the liquid phase, and the remaining gas portion becomes bubbles, moves upward inside the receiver 15, and is added to the gas phase. The primary refrigerant R1 retained as the liquid phase inside the receiver 15 is discharged to the outside of the receiver 15. Accordingly, the primary refrigerant R1 in a liquid state is constantly supplied from the receiver 15.

### Expansion Valve

The expansion valve 16 is a device that receives the primary refrigerant R1, which has entered a liquid state by passing through the receiver 15, and adiabatically expands the primary refrigerant R1. The expansion valve 16 and the receiver 15 are connected to each other by a second line 156 of the pre-expansion line 136. That is, one end of the second line 156 is connected to a refrigerant outlet section of the receiver 15, and the other end of the second line 156 is connected to the expansion valve 16.

The pressure of the primary refrigerant R1 introduced into the expansion valve 16 is decreased by an expansion effect of the expansion valve 16 to a predetermined pressure lower than before the expansion. As a result, the temperature of the primary refrigerant R1 becomes lower than before the expansion. Specifically, the primary refrigerant R1 having passed through the expansion valve 16 becomes a fluid in a two-phase state and is decreased to a temperature lower than the temperature of the secondary refrigerant R2, which is the other heat-exchange component.

The expansion valve 16 and the evaporator 12 are connected to each other by the post-expansion line 162, and the primary refrigerant R1 having passed through the expansion valve 16 is introduced into the evaporator 12 through the post-expansion line 162. That is, one end of the post-expansion line 162 is connected to the expansion valve 16, and the other end of the post-expansion line 162 is connected to a primary refrigerant inlet section 12a of the evaporator 12. The expansion valve 16 is supported by the post-expansion line 162 connected to the evaporator 12, and is held at a position separated from the main surface 11a of the base plate 11, for example.

### Casing

The casing 19 airtightly separates the device accommodation space S into a first space S1 on an outer side and a second space S2 on an inner side, and accommodates the compressor 14 and the condenser 13 in the second space S2. That is, the first space S1 and the second space S2 are in a nested relationship by the casing 19. The casing 19 is fixed to the main surface 11a of the base plate 11.

The casing 19 is a heat insulating member provided between the compressor 14 and the condenser 13, and other devices included in the refrigeration cycle 10 in the device accommodation space S. As a material constituting the casing 19, for example, rubber or resin is used. The casing 19 prevents air from moving from the second space S2 to the first space S1 and prevents direct heat transfer (thermal conduction) from the second space S2 to the first space S1 via the air.

In the present embodiment, a part of an outer surface of the casing 19 (a right side surface part of the casing 19 illustrated in FIG. 2) is joined to a side surface of the side wall portion 202. The casing 19 is formed with a casing hole 19a that extends from the inside toward an inner wall surface joined as described above. The casing hole 19a has the same shape and size as the hole portion 60 formed in the vehicle body inner wall 200, and is disposed corresponding to (overlapping) the hole portion 60.

### Leakage Sensor

The leakage sensor 17 is a gas sensor that can detect the concentration of the primary refrigerant R1 contained in air in an accommodating space. The leakage sensor 17 is provided in the device accommodation space S, and is located below (on the lower side in the vertical direction Dv of) the compressor 14, the condenser 13, and the evaporator 12 of the refrigeration cycle 10. Specifically, the leakage sensor 17 is provided at a bottom surface of the bottom wall portion 201. The leakage sensor 17 detects the concentration of the primary refrigerant R1 contained in the air in the accommodating space at predetermined time intervals, and transmits a signal indicating the concentration to the outside via a cable (wire harness) or the like.

As the leakage sensor 17 in the present embodiment, a semiconductor-type gas sensor that can detect an R290 refrigerant is used. A specific example of the leakage sensor 17 is TGS2610-D00 (an LP gas sensor) manufactured by Figaro Engineering. Inc.

### First Ventilating Port

The first ventilating port 51 is an air flow path communicating the device accommodation space S with the atmosphere outside the vehicle C. The first ventilating port 51 is located below the compressor 14, the condenser 13, and the evaporator 12 of the refrigeration cycle 10. The first ventilating port 51 in the present embodiment is a hole portion formed in the side wall portion 202 of the vehicle body inner wall 200.

### Ventilating Fan

The ventilating fan 50 is a ventilating fan 50 that can discharge the air in the device accommodation space S to the atmosphere outside the vehicle C through the first ventilating port 51. The ventilating fan 50 is provided at the first ventilating port 51. That is, the ventilating fan 50 in the present embodiment sends the air in the first space S1 of the device accommodation space S to the outside of the vehicle C.

### Air Intake

The air intake 53 is an air flow path communicating the device accommodation space S with the atmosphere outside the vehicle C independently of the first ventilating port 51. The air intake 53 is located above (on the upper side in the vertical direction Dv of) the compressor 14, the condenser 13, and the evaporator 12 of the refrigeration cycle 10. The air intake 53 in the present embodiment is, for example, a hole portion formed in the hood 203. Note that the air intake 53 may be a gap defined at a clearance between the hood 203 and the side wall portion 202.

When the ventilating fan 50 sends the air in the first space S1 to the atmosphere through the first ventilating port 51, air (the atmosphere) outside the vehicle C is introduced into the device accommodation space S through the air intake 53. Accordingly, the air in the first space S1 is ventilated.

### Second Ventilating Port

The second ventilating port 52 is formed by a combination of the casing hole 19a formed in the casing 19 and the hole portion 60 formed in the vehicle body inner wall 200. That is, the second ventilating port 52 is an air flow path communicating the second space S2 inside the casing 19 with the atmosphere outside the vehicle C not via the first space S1.

### Refrigeration-Cycle-Side Control Device

The refrigeration-cycle-side control device 18 is a device that stops operation of the compressor 14 of the refrigeration cycle 10 and drives the ventilating fan 50 based on detection information of the leakage sensor 17.

The refrigeration-cycle-side control device 18 is connected, by a cable (wire harness) or the like, to the leakage sensor 17, the compressor 14 of the refrigeration cycle 10, and a vehicle-side control device 40 that constitutes an engine control unit provided inside the vehicle C.

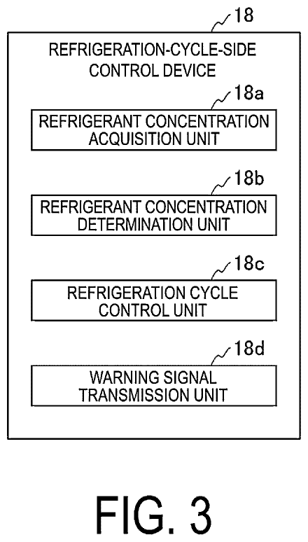

As illustrated in FIG. 3, the refrigeration-cycle-side control device 18 includes a refrigerant concentration acquisition unit 18a, a refrigerant concentration determination unit 18b, a refrigeration cycle control unit 18c, and a warning signal transmission unit 18d.

The refrigerant concentration acquisition unit 18a receives a signal transmitted from the leakage sensor 17 and acquires the concentration of the primary refrigerant R1 contained in the air in the device accommodation space S from the signal.

The refrigerant concentration determination unit 18b determines whether the primary refrigerant R1 leaks in the device accommodation space S based on the concentration of the primary refrigerant R1 acquired by the refrigerant concentration acquisition unit 18a. Specifically, the refrigerant concentration determination unit 18b determines whether the concentration of the primary refrigerant R1 acquired by the refrigerant concentration acquisition unit 18a is equal to or higher than a predetermined threshold value.

Here, the predetermined threshold value means an upper limit of a safe concentration range in which the primary refrigerant R1 does not explode by fire or the like. In the present embodiment, the upper limit of the safe concentration range is, for example, a lower explosive limit (LEL) of the primary refrigerant R1. When the primary refrigerant R1 is an R290 refrigerant, the lower explosive limit is 2.1%. On the other hand, a lower limit of the safe concentration range is 0%.

Thus, the safe concentration range in the present embodiment is 0% or more and less than 2.1%.

When the refrigerant concentration determination unit 18b determines that the concentration of the primary refrigerant R1 is equal to or higher than the predetermined threshold value, the refrigeration cycle control unit 18c stops operation of the refrigeration cycle 10 and drives the ventilating fan 50. Specifically, the refrigeration cycle control unit 18c transmits a signal indicating an operation stop instruction to the compressor 14, and then transmits a signal indicating a drive start instruction to the ventilating fan 50.

The compressor 14 stops operating upon receiving the signal indicating an operation stop instruction from the refrigeration cycle control unit 18c.

The ventilating fan 50 is driven upon receiving the signal indicating a drive start instruction from the refrigeration cycle control unit 18c. That is, the ventilating fan 50 starts to send the air in the device accommodation space S to the atmosphere through the first ventilating port 51.

When the refrigeration cycle control unit 18c transmits a signal indicating an operation stop instruction to the compressor 14, the warning signal transmission unit 18d transmits a signal indicating a warning to the vehicle-side control device 40. Upon receiving the signal indicating a warning from the warning signal transmission unit 18d, the vehicle-side control device 40 transmits a signal instructing lighting to a cabin warning light L provided at a driver's seat or the like in the vehicle C. The cabin warning light L starts lighting upon receiving the signal instructing lighting from the vehicle-side control device 40.

### Operation of Refrigeration-Cycle-Side Control Device

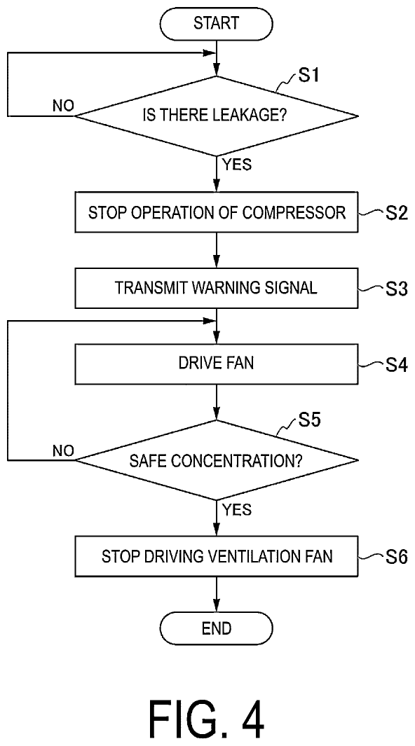

Next, an operation of the refrigeration-cycle-side control device 18 will be described with reference to FIG. 4.

The refrigerant concentration acquisition unit 18a acquires a concentration of the primary refrigerant R1. The refrigerant concentration determination unit 18b determines whether the primary refrigerant R1 leaks in the device accommodation space S (step S1).

When the refrigerant concentration determination unit 18b determines that there is leakage (step S1; YES), the refrigeration cycle control unit 18c transmits a signal indicating an operation stop instruction to the compressor 14. That is, the refrigeration cycle control unit 18c stops operation of the compressor 14 (step S2).

On the other hand, when the refrigerant concentration determination unit 18b determines that there is no leakage (step S1; NO), the processing returns to step S1.

After the signal indicating an operation stop instruction is transmitted to the compressor 14, the warning signal transmission unit 18d transmits a signal indicating a warning to the vehicle-side control device 40 (step S3).

After the signal indicating a warning is transmitted to the vehicle-side control device 40, the refrigeration cycle control unit 18c transmits a signal indicating a drive start instruction to the ventilating fan 50. That is, the refrigeration cycle control unit 18c drives the ventilating fan 50 (step S4).

After the signal indicating a drive start instruction is transmitted to the ventilating fan 50, the refrigerant concentration determination unit 18b determines whether the concentration of the primary refrigerant R1 is equal to or higher than a predetermined threshold value. That is, the refrigerant concentration determination unit 18b determines whether the concentration of the primary refrigerant R1 contained in air in the device accommodation space S is within the safe concentration range (step S5).

In a case where it is determined that the concentration of the primary refrigerant R1 is within the safe concentration range (step S5; YES), the refrigeration cycle control unit 18c transmits a signal indicating a drive stop instruction to the ventilating fan 50. That is, the refrigeration cycle control unit 18c stops driving the ventilating fan 50 (step S6).

When the driving of the ventilating fan 50 is stopped, the operation of the refrigeration-cycle-side control device 18 is terminated.

On the other hand, in a case where it is determined that the concentration of the primary refrigerant R1 is not within the safe concentration range (step S5; NO), the processing returns to step S4.

### Vehicle-Inside Thermal Fluid Circuit

The vehicle-inside thermal fluid circuit 20 is a refrigerant circuit through which the secondary refrigerant R2 having exchanged heat with the primary refrigerant R1 in the refrigeration cycle 10 flows and which conditions air in the vehicle interior. As the secondary refrigerant R2 in the present embodiment, for example, an antifreezing fluid such as ethylene glycol is used.

As illustrated in FIG. 1, the vehicle-inside thermal fluid circuit 20 includes a heater core 21a (vehicle-inside heat exchanger 21), a cooler core 21b (vehicle-inside heat exchanger 21), a first pump 22, a first valve 23, a second valve 24, and various lines (a first thermal fluid line 20a to a seventh thermal fluid line 20g).

The heater core 21a and the cooler core 21b are heat exchangers for causing cabin air inside the vehicle C and ambient air outside the vehicle C to exchange heat with the secondary refrigerant R2. The secondary refrigerant R2 having passed through the condenser 13 of the vehicular refrigeration cycle unit 100 is introduced into the heater core 21a. In the process of introducing the secondary refrigerant R2 from the condenser 13 to the heater core 21a, the secondary refrigerant R2 passes through the first pump 22 and the first valve 23.

The first pump 22 is a pump that pumps the secondary refrigerant R2 heated by the condenser 13 to the heater core 21a. The first thermal fluid line 20a serving as a flow path for suctioning the secondary refrigerant R2 into the first pump 22 connects the condenser 13 and the first pump 22. That is, one end of the first thermal fluid line 20a is connected to a secondary refrigerant outlet section 13d of the condenser 13, and the other end of the first thermal fluid line 20a is connected to a refrigerant suction port of the first pump 22.

A second thermal fluid line 20b serving as a flow path for discharging the secondary refrigerant R2 from the first pump 22 toward the heater core 21a connects the first pump 22 and the first valve 23. That is, one end of the second thermal fluid line 20b is connected to a refrigerant discharge port of the first pump 22, and the other end of the second thermal fluid line 20b is connected to the first valve 23. The first valve 23 is a three-way valve that can change the flow path (destination) of the secondary refrigerant R2.

The first valve 23 and the heater core 21a are connected by a third thermal fluid line 20c. That is, one end of the third thermal fluid line 20c is connected to the first valve 23, and the other end of the third thermal fluid line 20c is connected to the heater core 21a.

The secondary refrigerant R2 introduced into the heater core 21a is cooled by heat exchange with the cabin air inside the vehicle C and the ambient air introduced into the vehicle C from the outside of the vehicle C while heating the cabin air and the ambient air. As a result, these mixed cabin airs inside the vehicle body can be heated. For example, air outside the vehicle body introduced by a fan (not illustrated) disposed upstream of the cooler core 21b is used as the ambient air.

The secondary refrigerant R2 cooled in the heater core 21a is returned to the condenser 13 via the second valve 24. The second valve 24 is a three-way valve that can change the flow path (destination) of the secondary refrigerant R2. The second valve 24 and the heater core 21a are connected by a fourth thermal fluid line 20d. That is, one end of the fourth thermal fluid line 20d is connected to a refrigerant outlet section of the heater core 21a, and the other end of the fourth thermal fluid line 20d is connected to the second valve 24.

The second valve 24 and the condenser 13 are connected by a fifth thermal fluid line 20e. That is, one end of the fifth thermal fluid line 20e is connected to the second valve 24, and the other end of the fifth thermal fluid line 20e is connected to a secondary refrigerant inlet section 13c of the condenser 13.

With the configuration described above, the secondary refrigerant R2 sequentially flows through the condenser 13, the first pump 22, and the heater core 21a, and returns to the condenser 13. By repeating this circulation, the heating operation is achieved, and the temperature inside the vehicle can be continuously heated.

Here, the cooler core 21b is provided in the vehicle body independently of the heater core 21a. During the cooling operation, the secondary refrigerant R2 having passed through the evaporator 12 is introduced into the cooler core 21b, and heat is exchanged between the secondary refrigerant R2 and outside air. The flow of the secondary refrigerant R2 during the cooling operation will be described below.

### Vehicle-Outside Thermal Fluid Circuit

The vehicle-outside thermal fluid circuit 30 is a refrigerant circuit through which the secondary refrigerant R2 having exchanged heat with the primary refrigerant R1 in the refrigeration cycle 10 flows and which cools a battery that powers the vehicle body.

The vehicle-outside thermal fluid circuit 30 includes a vehicle-outside heat exchanger 31, a second pump 32, various valves (a third valve 33 and a fifth valve 35), a battery cooler 36, and various lines (an eighth thermal fluid line 30a to a twelfth thermal fluid line 30e, and a first connection line 30f to a fourth connection line 30i).

The vehicle-outside heat exchanger 31 is a heat exchanger for exchanging heat between ambient air and the secondary refrigerant R2. A part of the secondary refrigerant R2 having passed through the evaporator 12 of the vehicular refrigeration cycle unit 100 is introduced into the vehicle-outside heat exchanger 31 via the third valve 33. The remaining part of the secondary refrigerant R2 having passed through the evaporator 12 is introduced into the battery cooler 36 via the fourth valve 34.

The evaporator 12 is connected to the third valve 33 and the fourth valve 34 by the eighth thermal fluid line 30a. Specifically, one end of the eighth thermal fluid line 30a is connected to a secondary refrigerant outlet section 12d of the evaporator 12, and the other end of the eighth thermal fluid line 30a is branched in two directions partway along the eighth thermal fluid line 30a and connected to the third valve 33 and the fourth valve 34, respectively. The third valve 33 and the fourth valve 34 are three-way valves that can change the flow path (destination) of the secondary refrigerant R2.

The third valve 33 and the vehicle-outside heat exchanger 31 are connected by a ninth thermal fluid line 30b. That is, one end of the ninth thermal fluid line 30b is connected to the third valve 33, and the other end of the ninth thermal fluid line 30b is connected to a refrigerant inlet section of the vehicle-outside heat exchanger 31.

The secondary refrigerant R2 introduced into the vehicle-outside heat exchanger 31 through the eighth thermal fluid line 30a, the third valve 33, and the ninth thermal fluid line 30b is heated by heat exchange with ambient air. Accordingly, the secondary refrigerant R2 becomes higher in temperature than the primary refrigerant R1 introduced into the evaporator 12 and can heat the primary refrigerant R1 flowing through the refrigeration cycle 10 in the evaporator 12. Outside air, which is the other heat exchange component of the vehicle-outside heat exchanger 31, is suctioned from the outside of the vehicle body via a front grille F by a fan B provided on a front side inside the vehicle C.

The second pump 32 is a pump that pumps the secondary refrigerant R2 heated by the vehicle-outside heat exchanger 31 to the evaporator 12. The secondary refrigerant R2 having passed through the vehicle-outside heat exchanger 31 passes through the fifth valve 35 in the process of being suctioned into the second pump 32. The fifth valve 35 is a three-way valve that can change the flow path (destination) of the secondary refrigerant R2.

The fifth valve 35 and the vehicle-outside heat exchanger 31 are connected by a tenth thermal fluid line 30c. That is, one end of the tenth thermal fluid line 30c is connected to the vehicle-outside heat exchanger 31, and the other end of the tenth thermal fluid line 30c is connected to the fifth valve 35.

An eleventh thermal fluid line 30d serving as a flow path for suctioning the secondary refrigerant R2 into the second pump 32 connects the fifth valve 35 and the second pump 32. That is, one end of the eleventh thermal fluid line 30d is connected to the fifth valve 35, and the other end of the eleventh thermal fluid line 30d is connected to the second pump 32.

The second pump 32 and the evaporator 12 are connected by the twelfth thermal fluid line 30e. That is, one end of the twelfth thermal fluid line 30e is connected to the second pump 32, and the other end of the twelfth thermal fluid line 30e is connected to a secondary refrigerant inlet section 12c of the evaporator 12. Thus, the secondary refrigerant R2 pumped by the second pump 32 is introduced into the evaporator 12.

With the configuration described above, the secondary refrigerant R2 sequentially flows through the evaporator 12, the vehicle-outside heat exchanger 31, and the second pump 32, and returns to the evaporator 12. By repeating this circulation, the primary refrigerant R1 circulating in the refrigeration cycle 10 can be continuously heated by heat exchange in the evaporator 12.

Accordingly, the vehicular refrigeration cycle unit 100 is interposed between the vehicle-outside heat exchanger 31 and the heater core 21a (vehicle-inside heat exchanger 21) and performs heat exchange between the secondary refrigerant R2 flowing through the vehicle-outside heat exchanger 31 and the secondary refrigerant R2 flowing through the vehicle-inside heat exchanger 21.

The battery cooler 36 is a heat exchanger for cooling a battery. The battery cooler 36 is provided inside the vehicle C. The above-described remaining part of the secondary refrigerant R2 cooled by the evaporator 12 and flowing through the eighth thermal fluid line 30a is introduced into the battery cooler 36 via the fourth valve 34. The fourth valve 34 and the battery cooler 36 are connected by a first connection line 30f. That is, one end of the first connection line 30f is connected to the fourth valve 34, and the other end of the first connection line 30f is connected to a refrigerant inlet section of the battery cooler 36.

The secondary refrigerant R2 heated by heat exchange with the battery (not illustrated) in the battery cooler 36 is returned to the evaporator 12. The battery cooler 36 and the eleventh thermal fluid line 30d are connected by the second connection line 30g. Specifically, one end of the second connection line 30g is connected to a refrigerant outlet section of the battery cooler 36, and the other end of the second connection line 30g is connected to a portion of the eleventh thermal fluid line 30d on the fifth valve 35 side with respect to the second pump 32. Thus, the secondary refrigerant R2 having passed through the battery cooler 36 joins the eleventh thermal fluid line 30d via the second connection line 30g, and is pumped to the evaporator 12 again by the second pump 32.

Here, the fourth valve 34 and the cooler core 21b are connected by a sixth thermal fluid line 20f. That is, one end of the sixth thermal fluid line 20f is connected to the fourth valve 34, and the other end of the sixth thermal fluid line 20f is connected to a refrigerant inlet section of the cooler core 21b. In addition, the cooler core 21b and the second connection line 30g are connected by the seventh thermal fluid line 20g. That is, one end of the seventh thermal fluid line 20g is connected to the cooler core 21b, and the other end of the seventh thermal fluid line 20g is connected to the second connection line 30g. Thus, the secondary refrigerant R2 having passed through the evaporator 12 during the cooling operation of the vehicular air conditioning system 1 can flow into the cooler core 21b via the fourth valve 34.

During the heating operation, the fourth valve 34 causes the secondary refrigerant R2 having flowed in from the eighth thermal fluid line 30a to flow only to the first connection line 30f without flowing to the sixth thermal fluid line 20f. That is, the fourth valve 34 does not supply the secondary refrigerant R2 to the cooler core 21b, but supplies the secondary refrigerant R2 only to the battery cooler 36.

Further, the first valve 23 and the fifth valve 35 are connected by the third connection line 30h. That is, one end of the third connection line 30h is connected to the first valve 23, and the other end of the third connection line 30h is connected to the fifth valve 35.

During the heating operation, the first valve 23 causes the secondary refrigerant R2 having flowed in from the second thermal fluid line 20b to flow only to the third thermal fluid line 20c without flowing to the third connection line 30h. The fifth valve 35 causes the secondary refrigerant R2 having flowed in from the tenth thermal fluid line 30c to flow only to the eleventh thermal fluid line 30d without flowing to the third connection line 30h.

In addition, the second valve 24 and the third valve 33 are connected by the fourth connection line 30i. That is, one end of the fourth connection line 30i is connected to the second valve 24, and the other end of the fourth connection line 30i is connected to the third valve 33.

During the heating operation, the second valve 24 causes the secondary refrigerant R2 having flowed in from the fourth thermal fluid line 20d to flow only to the fifth thermal fluid line 20e without flowing to the fourth connection line 30i. The third valve 33 causes the secondary refrigerant R2 having flowed in from the eighth thermal fluid line 30a to flow only to the ninth thermal fluid line 30b without flowing to the fourth connection line 30i.

### Operational Effects

The vehicular refrigeration cycle unit 100 according to the above-described embodiment includes the leakage sensor 17 located below the compressor 14, the condenser 13, the expansion valve 16, and the evaporator 12 and that can detect the concentration of the primary refrigerant R1 in air inside the device accommodation space S. Accordingly, when the primary refrigerant R1 leaks due to an abnormality occurring in any of the compressor 14, the condenser 13, and the evaporator 12 and the leaked primary refrigerant R1 comes down, an increase in the concentration of the primary refrigerant R1 is detected by the leakage sensor 17. Thus, the presence or absence of a leakage of the primary refrigerant R1 can be determined based on the concentration detected by the leakage sensor 17.

In addition, the vehicular refrigeration cycle unit 100 according to the above-described embodiment includes the first ventilating port 51 and the ventilating fan 50 that can discharge the air in the device accommodation space S to the atmosphere outside the vehicle C through the first ventilating port 51. Thus, the leaked flammable primary refrigerant R1 can be actively discharged to the atmosphere without being retained in the device accommodation space S. Therefore, the inside of the device accommodation space S can be maintained safely.

In the vehicular refrigeration cycle unit 100 according to the above-described embodiment, the control device stops operation of the compressor 14 and drives the ventilating fan 50 based on detection information of the leakage sensor 17. Accordingly, the primary refrigerant R1 in the device accommodation space S can be discharged to the atmosphere at a necessary timing, and the control device stops operation of the compressor 14, so that further leakage of the primary refrigerant R1 can be prevented. Therefore, the inside of the device accommodation space S can be maintained more safely.

In addition, the vehicular refrigeration cycle unit 100 according to the above-described embodiment includes the air intake 53 communicating the device accommodation space S with the atmosphere outside the vehicle C independently of the first ventilating port 51. Accordingly, air in the atmosphere can be introduced from the air intake 53 along with the discharge of the air in the device accommodation space S from the first ventilating port 51. Accordingly, the air in the device accommodation space S can be entirely ventilated, and the inside of the device accommodation space S can be prevented from having a negative pressure.

In the vehicular refrigeration cycle unit 100 according to the above-described embodiment, when the primary refrigerant R1 leaks from the compressor 14 and the condenser 13, the leaked primary refrigerant R1 can be retained in the second space S2 inside the casing 19. Further, since the second space S2 has a positive pressure due to the leaked primary refrigerant R1, the primary refrigerant R1 in the second space S2 can be guided to the atmosphere through the second ventilating port 52. Accordingly, when the primary refrigerant R1 leaks from the compressor 14 and the condenser 13, the leaked primary refrigerant R1 can be prevented from spreading to the entire inside of the device accommodation space S.

In addition, since the device accommodation space S is partitioned into the first space S1 and the second space S2 by the casing 19, it is possible to determine from which device included in the refrigeration cycle 10 the primary refrigerant R1 has leaked.

### OTHER EMBODIMENTS

Embodiments of the present disclosure have been described above in detail with reference to the drawings. However, specific configurations are not limited to the configurations of the embodiments. Any configuration can be added, omitted, substituted, or otherwise modified, as long as such addition, omission, substitution, or modification does not depart from the scope of the present disclosure. Furthermore, the present disclosure is not to be considered as being limited by the embodiments and is only limited by the scope of the appended claims.

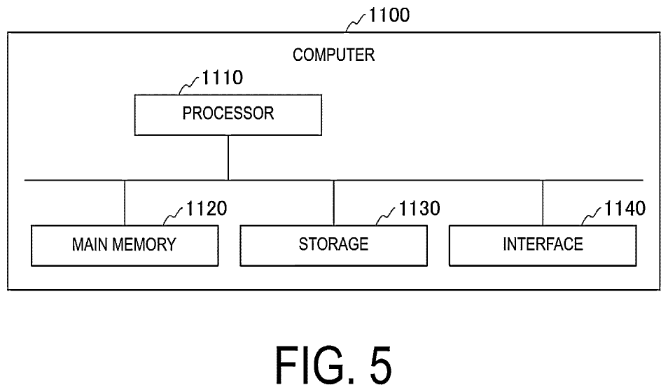

Note that FIG. 5 is a hardware configuration diagram illustrating a configuration of a computer 1100 according to the present embodiment.

The computer 1100 includes a processor 1110, a main memory 1120, a storage 1130, and an interface 1140.

The above-described refrigeration-cycle-side control device 18 is implemented in the computer 1100. In addition, operation of each of the above-described processing units is stored in the storage 1130 in the form of a program. The processor 1110 reads the program from the storage 1130, deploys the program in the main memory 1120, and executes the processing described above according to the program. Furthermore, the processor 1110 secures a storage area corresponding to each of the above-described storage units in the main memory 1120 according to the program.

The program may be a program for achieving some of the functions that the computer 1100 is caused to perform. For example, the program may be one that achieves a function in combination with another program already stored in the storage 1130, or in combination with another program implemented in another device. Furthermore, the computer 1100 may include a custom large-scale integrated circuit (LSI) such as a programmable logic device (PLD) in addition to or in place of the configuration described above. Examples of the PLD include a programmable array logic (PAL), a generic array logic (GAL), a complex programmable logic device (CPLD), and a field programmable gate array (FPGA). In this case, some or all of the functions achieved by the processor 1110 may be achieved by the integrated circuit.

Examples of the storage 1130 include a magnetic disk, a magneto-optic disk, and a semiconductor memory. The storage 1130 may be an internal medium directly connected to a bus of the computer 1100, or may be an external medium connected to the computer 1100 via the interface 1140 or a communication line. Furthermore, when this program is delivered to the computer 1100 via a communication line, after receiving the delivery, the computer 1100 may deploy the program in the main memory 1120 and execute the processing described above. In the present embodiment, the storage 1130 is a non-temporary tangible storage medium.

Furthermore, the program may be a program for achieving some of the functions described above. Further, the program may be a so-called differential file (differential program) that achieves the functions described above in combination with another program already stored in the storage 1130.

In addition, in the embodiments, the configuration in which the vehicular air conditioning system 1 performs the heating operation has been described as an example. However, the present invention is not limited to the heating operation, and the vehicular refrigeration cycle unit 100 may employ the same configuration as the configuration of the above-described embodiment even in performing a cooling operation.

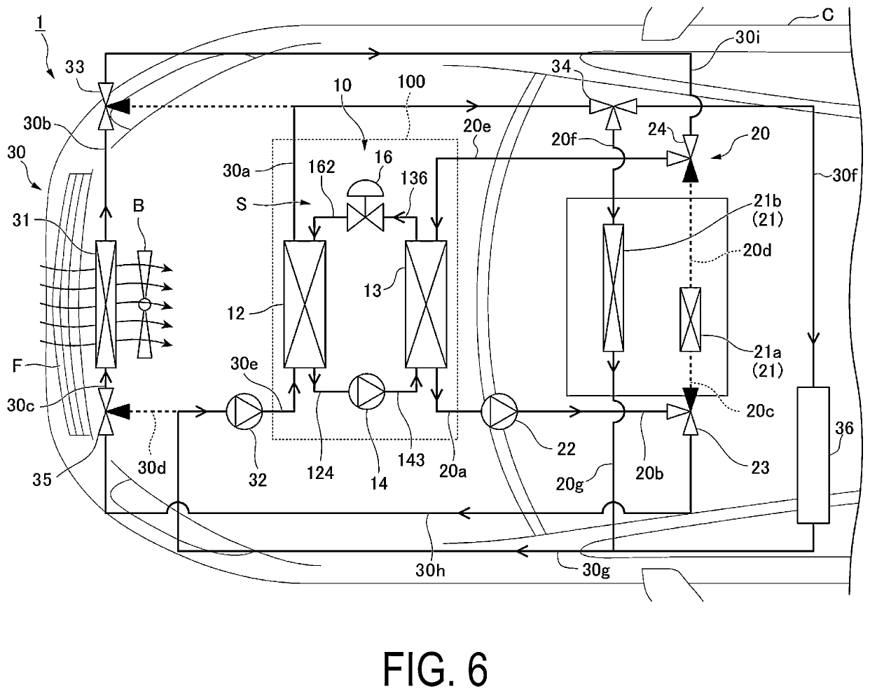

Hereinafter, configurations of the vehicle-inside thermal fluid circuit 20 and the vehicle-outside thermal fluid circuit 30 during the cooling operation will be described with reference to FIG. 6.

The first pump 22 pumps the secondary refrigerant R2 heated by the condenser 13 to the vehicle-outside heat exchanger 31. The first thermal fluid line 20a serving as a flow path for suctioning the secondary refrigerant R2 into the first pump 22 connects the condenser 13 and the first pump 22.

The second thermal fluid line 20b serving as a flow path for discharging the secondary refrigerant R2 from the first pump 22 toward the vehicle-outside heat exchanger 31 connects the first pump 22 and the first valve 23. Here, the first valve 23 causes the secondary refrigerant R2 discharged from the first pump 22 to flow to the fourth connection line 30i without flowing to the third thermal fluid line 20c. The secondary refrigerant R2 having flowed in the fourth connection line 30i flows into the third valve 33.

Here, the third valve 33 causes the secondary refrigerant R2 having flowed in from the fourth connection line 30i to flow to the tenth thermal fluid line 30c without flowing to the eleventh thermal fluid line 30d. The secondary refrigerant R2 having flowed in the tenth thermal fluid line 30c flows into the vehicle-outside heat exchanger 31.

The secondary refrigerant R2 having passed through the vehicle-outside heat exchanger 31 flows into the fourth valve 34 through the ninth thermal fluid line 30b. Thus, a flow direction of the secondary refrigerant R2 flowing through the tenth thermal fluid line 30c, the vehicle-outside heat exchanger 31, and the ninth thermal fluid line 30b during the cooling operation of the vehicular air conditioning system 1 is opposite to a flow direction of the secondary refrigerant R2 during the heating operation.

Here, the fourth valve 34 causes the secondary refrigerant R2 having flowed in from the ninth thermal fluid line 30b to flow to the third connection line 30h without flowing to the eighth thermal fluid line 30a. The secondary refrigerant R2 having flowed in the third connection line 30h flows into the second valve 24.

Here, the second valve 24 causes the secondary refrigerant R2 having flowed in from the third connection line 30h to flow to the fifth thermal fluid line 20e without flowing to the fourth thermal fluid line 20d. The secondary refrigerant R2 having flowed in the fifth thermal fluid line 20e flows into the condenser 13.

With the configuration described above, the secondary refrigerant R2 sequentially flows through the condenser 13, the first pump 22, and the vehicle-outside heat exchanger 31, and returns to the condenser 13. By repeating this circulation, the primary refrigerant R1 circulating in the refrigeration cycle 10 can be continuously cooled by heat exchange in the condenser 13.

The second pump 32 pumps the secondary refrigerant R2 cooled by the evaporator 12 to the cooler core 21b. The secondary refrigerant R2 having passed through the evaporator 12 flows into the eighth thermal fluid line 30a by the suction force of the pump and then flows into the fifth valve 35. Here, the fifth valve 35 causes the secondary refrigerant R2 having flowed in from the eighth thermal fluid line 30a to flow to both the sixth thermal fluid line 20f and the first connection line 30f.

The secondary refrigerant R2 having flowed in the sixth thermal fluid line 20f flows into the cooler core 21b. The secondary refrigerant R2 having completed heat exchange in the cooler core 21b flows into the seventh thermal fluid line 20g and then flows into the second connection line 30g. The secondary refrigerant R2 having flowed in the second connection line 30g flows into the eleventh thermal fluid line 30d, and returns to the evaporator 12 via the second pump 32 and the twelfth thermal fluid line 30e.

The secondary refrigerant R2 having flowed in the first connection line 30f flows into the battery cooler 36. Thus, the battery cooler 36 exchanges heat with (is cooled by) the secondary refrigerant R2 during both the heating operation and the cooling operation of the vehicular air conditioning system 1. The secondary refrigerant R2 having completed heat exchange in the battery cooler 36 flows into the second connection line 30g. The secondary refrigerant R2 having flowed in the second connection line 30g flows into the eleventh thermal fluid line 30d, and returns to the evaporator 12 via the second pump 32 and the twelfth thermal fluid line 30e.

With the configuration described above, the secondary refrigerant R2 sequentially flows through the evaporator 12, the cooler core 21b, and the second pump 32, and returns to the evaporator 12. By repeating this circulation, the cooling operation is achieved, and the temperature inside the vehicle can be continuously cooled.

In the embodiment, an example in which an R290 refrigerant is used as the primary refrigerant R1 and ethylene glycol is used as the secondary refrigerant R2 has been described, but other refrigerants may be used as the primary refrigerant R1 and the secondary refrigerant R2.

In the embodiment, the configuration in which the base plate 11 extends in the horizontal direction H has been described, but the present invention is not limited to this configuration. For example, the base plate 11 in the device accommodation space S may extend in a direction perpendicular to the horizontal direction H, and the main surface 11a of the base plate 11 may face the horizontal direction H.

The casing 19 in the embodiment may be integrally formed with the vehicle body inner wall 200 and may be a part of the vehicle body inner wall 200. In addition, although the vehicular refrigeration cycle unit 100 includes the casing 19 and the second ventilating port 52, the vehicular refrigeration cycle unit 100 may not include the casing 19 and the second ventilating port 52.

The vehicular refrigeration cycle unit 100 in the embodiment may further include the leakage sensor 17 provided below the compressor 14 and the condenser 13 in the second space S2 inside the casing 19.

In the embodiment, the first ventilating port 51 is a hole portion formed in the side wall portion 202 of the vehicle body inner wall 200. However, the present invention is not limited to this configuration, and the first ventilating port 51 may be a hole portion formed in the bottom wall portion 201 of the vehicle body inner wall 200.

### Supplementary Notes

The vehicular refrigeration cycle unit described in the above embodiments is understood as follows, for example.

(1) A vehicular refrigeration cycle unit 100 according to a first aspect is a vehicular refrigeration cycle unit 100 interposed between a vehicle-outside heat exchanger 31 and a vehicle-inside heat exchanger 21 and being configured to exchange heat between respective secondary refrigerants R2 flowing through the vehicle-outside heat exchanger 31 and the vehicle-inside heat exchanger 21, the refrigeration cycle unit including: a refrigeration cycle 10 provided in a device accommodation space S inside a vehicle C, the refrigeration cycle 10 including a compressor 14, a condenser 13, an expansion valve 16, and an evaporator 12 through which a primary refrigerant R1 having flammability and having a higher specific gravity than atmosphere sequentially flows; and a leakage sensor 17 located below the compressor 14, the condenser 13, and the evaporator 12 and being configured to detect a concentration of the primary refrigerant R1 contained in air in the device accommodation space S.

Accordingly, when the primary refrigerant R1 leaks due to an abnormality occurring in any of the compressor 14, the condenser 13, and the evaporator 12, the leaked primary refrigerant R1 comes down. At this time, an increase in the concentration of the primary refrigerant R1 is detected by the leakage sensor 17.

(2) A vehicular refrigeration cycle unit 100 according to a second aspect is the vehicular refrigeration cycle unit 100 according to (1), wherein a first ventilating port 51 communicating the device accommodation space S with an atmosphere outside the vehicle C, and a ventilating fan 50 that can discharge the air in the device accommodation space S to the atmosphere outside the vehicle C through the first ventilating port 51 may be further included.

Accordingly, the leaked primary refrigerant R1 can be actively discharged to the atmosphere without being retained in the device accommodation space S.

(3) A vehicular refrigeration cycle unit 100 according to a third aspect is the vehicular refrigeration cycle unit 100 according to (2), wherein a control device that stops operation of the compressor 14 and drives the ventilating fan 50 based on detection information of the leakage sensor 17 may be further included.

Accordingly, the primary refrigerant R1 in the device accommodation space S can be discharged to the atmosphere at a necessary timing, and the operation of the compressor 14 is stopped, so that further leakage of the primary refrigerant R1 can be prevented.

(4) A vehicular refrigeration cycle unit 100 according to a fourth aspect is the vehicular refrigeration cycle unit 100 according to (2) or (3), wherein an air intake 53 communicating the device accommodation space S with the atmosphere outside the vehicle C independently of the first ventilating port 51 may be further included.

Accordingly, air in the atmosphere can be introduced from the air intake 53 along with the discharge of the air in the device accommodation space S from the first ventilating port 51.

(5) A vehicular refrigeration cycle unit 100 according to a fifth aspect is the vehicular refrigeration cycle unit 100 according to any one of (2) to (4), wherein a casing 19 that airtightly separates the device accommodation space S into a first space S1 on an outer side and a second space S2 on an inner side and accommodates the compressor 14 and the condenser 13 in the second space S2, and a second ventilating port 52 communicating the second space S2 with the atmosphere outside the vehicle C not via the first space S1 may be further included.

Accordingly, when the primary refrigerant R1 leaks from the compressor 14 and the condenser 13, the leaked primary refrigerant R1 can be retained in the second space S2 inside the casing 19, and the primary refrigerant R1 in the second space S2 can be guided to the atmosphere through the second ventilating port 52. In addition, it is possible to determine from which device included in the refrigeration cycle 10 the primary refrigerant R1 has leaked.

### INDUSTRIAL APPLICABILITY

According to the present disclosure, a vehicular refrigeration cycle unit that can determine the presence or absence of a leakage of a primary refrigerant can be provided.

### REFERENCE SIGNS LIST

1 Vehicular air conditioning system, 10 Refrigeration cycle, 11 Base plate, 11a Main surface, 12 Evaporator, 12a, 13a Primary refrigerant inlet section, 12b, 13b Primary refrigerant outlet section, 12c, 13c Secondary refrigerant inlet section, 12d, 13d Secondary refrigerant outlet section, 13 Condenser, 14 Compressor, 15 Receiver, 16 Expansion valve, 17 Leakage sensor, 18 Refrigeration-cycle-side control device, 18a Refrigerant concentration acquisition unit, 18b Refrigerant concentration determination unit, 18c Refrigeration cycle control unit, 18d Warning signal transmission unit, 19 Casing, 19a Casing hole, 20 Vehicle-inside thermal fluid circuit, 20a First thermal fluid line, 20b Second thermal fluid line, 20c Third thermal fluid line, 20d Fourth thermal fluid line, 20e Fifth thermal fluid line, 20f Sixth thermal fluid line, 20g Seventh thermal fluid line, 21 Vehicle-inside heat exchanger, 21a Heater core, 21b Cooler core, 22 First pump, 23 First valve, 24Second valve, 30 Vehicle-outside thermal fluid circuit, 30a Eighth thermal fluid line, 30b Ninth thermal fluid line, 30c Tenth thermal fluid line, 30d Eleventh thermal fluid line, 30e Twelfth thermal fluid line, 30f First connection line, 30g Second connection line, 30h Third connection line, 30i Fourth connection line, 31 Vehicle-outside heat exchanger, 32 Second pump, 33 Third valve, 34 Fourth valve, 35 Fifth valve, 36 Battery cooler, 40 Vehicle-side control device, 50 Ventilating fan, 51 First ventilating port, 52 Second ventilating port, 53 Air intake, 60 Hole portion, 100 Vehicular refrigeration cycle unit, 120, 130 Heat exchange portion, 121 Evaporator plate, 122a, 122b, 132a, 132b Heat exchange flow path, 124 Suction line, 131 Condenser plate, 135 First line, 136 Pre-expansion line, 143 Discharge line, 156 Second line, 162 Post-expansion line, 200 Vehicle body inner wall, 201 Bottom wall portion, 202 Side wall portion, 203 Hood, 1100 Computer, 1110 Processor, 1120 Main memory, 1130 Storage, 1140 Interface, B Fan, C Vehicle, Dv Vertical direction, F Front grille, H Horizontal direction, L Cabin warning light, R1 Primary refrigerant, R2 Secondary refrigerant, S Device accommodation space, S1 First space, S2 Second space

1. A vehicular refrigeration cycle unit interposed between a vehicle-outside heat exchanger and a vehicle-inside heat exchanger and being configured to exchange heat between secondary refrigerants respectively flowing through the vehicle-outside heat exchanger and the vehicle-inside heat exchanger, the vehicular refrigeration cycle unit comprising:
a refrigeration cycle provided in a device accommodation space inside a vehicle, the refrigeration cycle including a compressor, a condenser, an expansion valve, and an evaporator through which a primary refrigerant having flammability and having a higher specific gravity than atmosphere flows sequentially; and
a leakage sensor located below the compressor, the condenser, and the evaporator and being configured to detect a concentration of the primary refrigerant contained in air in the device accommodation space.

2. The vehicular refrigeration cycle unit according to claim 1, further comprising
a first ventilating port communicating the device accommodation space with an atmosphere outside the vehicle, and
a ventilating fan configured to discharge the air in the device accommodation space to the atmosphere outside the vehicle through the first ventilating port.

3. The vehicular refrigeration cycle unit according to claim 2, further comprising a control device configured to stop operation of the compressor and drive the ventilating fan based on detection information of the leakage sensor.

4. The vehicular refrigeration cycle unit according to claim 2, further comprising an air intake communicating the device accommodation space with the atmosphere outside the vehicle independently of the first ventilating port.

5. The vehicular refrigeration cycle unit according to claim 2, further comprising:
a casing airtightly separating the device accommodation space into a first space on an outer side and a second space on an inner side and accommodating the compressor and the condenser in the second space, and
a second ventilating port communicating the second space with the atmosphere outside the vehicle not via the first space.
